(19) United States
(12) Patent Application Publication
(10) Pub. No.: US 2011/0262610 A1
(43) Pub. Date: Oct. 27, 2011

(54) WASABI LEAF FOODS

(76) Inventors: Akemi Nishimoto, Fukuoka (JP); Aiko Nishimoto, Fukuoka (JP)

(21) Appl. No.: 12/998,059

(22) PCT Filed: Oct. 28, 2010
(86) PCT No.: PCT/JP2010/069135

§ 371 Date: Apr. 15, 2011

(30) Foreign Application Priority Data
Oct. 30, 2009 (JP) 2009-249679

(51) Int. Cl. A23L 1/214

(52) U.S. Cl. 426/534; 426/615

(57) ABSTRACT

A wasabi leaf food is provided in which an eating texture of which can be enjoyed while keeping the inherent fragrance in wasabi is provided. Therefore, the wasabi leaf food contains a wasabi leaf in an amount of 95% by mass, wherein a content of a leaf part of the wasabi leaf is 5 to 10% by mass, a content of a stem part of the wasabi leaf is 75 to 80% by mass, and a remaining part is composed of a root part, as well as grain diameters of the leaf, the stem, and the root of the wasabi leaf are 1 mm to 5 mm.

### BACKGROUND OF THE INVENTION

The present invention relates to a wasabi leaf food, and particularly relates to the wasabi leaf food containing grains obtained by crushing a leaf part, a stem part and a root part of the wasabi leaf.

Conventionally, paste wasabi products in tubes and the like have been commercially available as foods having a wasabi flavor (for example, see Japanese Published Unexamined Patent Application No. 2002-176949-A). The paste wasabi product in the tube is generally manufactured as follows.

That is, frozen wasabi or horseradish is thawed, its surface is washed with water, and drained followed by crushing it to obtain a crushed wasabi paste. Subsequently, an additive composed of a pH adjuster such as citric acid, a coloring agent and an essence is added to this crushed wasabi paste, and the mixture is stirred and mixed to obtain a paste wasabi. A tube made from a synthesized resin is filled with this paste wasabi and then sealed, thereby obtaining the paste wasabi product that is a final product having a conservative property.

However, the paste wasabi product is manufactured by stirring and mixing the crushed wasabi paste obtained by crushing the wasabi. Thus, the inherent fragrance in wasabi cannot be sensed and its eating texture cannot be enjoyed.

The present invention has been made in view of the above points, and an object thereof is to provide a wasabi leaf food, the eating texture of which can be enjoyed while keeping the inherent fragrance in wasabi.

### SUMMARY OF THE INVENTION

In order to achieve the above object, the wasabi leaf food of the present invention contains a wasabi leaf containing 5 to 10% by mass of a leaf part, 75 to 80% by mass of a stem part, and a root part in a remaining portion, as well as having a grain diameter of 1 mm to 5 mm.

First, as a result of an extensive study, the present inventors have found that “the leaf of the wasabi leaf has a strong fragrance but is not as pungent as the root, the stem has a fragrance and pungent taste but is not so fragrant as the leaf and is not as pungent as the root, and the root has a strong pungent taste but is not as fragrant as the leaf.” The inventors have also found that it is extremely important for keeping the inherent fragrance in wasabi to appropriately mix the leaf part, the stem part, and the root part of the wasabi leaf.

Then, a color like real wasabi is realized, as well as realizing a product with no odor by making the ratio of the leaf of the wasabi leaf 5 to 10% by mass.

That is, when the ratio of the leaf of the wasabi leaf is less than 5% by mass, coloration is insufficient, and the color that stimulates an appetite cannot be realized. Meanwhile, when the ratio of the leaf of the wasabi leaf exceeds 10% by mass, a raw taste is generated. Thus, the ratio of the leaf of the wasabi leaf is limited to 5 to 10% by mass in the wasabi leaf food of the present invention.

Also, sufficient eating texture is realized by making the ratio of the stem of the wasabi leaf 75 to 80% by mass.

That is, when the ratio of the stem of the wasabi leaf is less than 75% by mass, the eating texture becomes insufficient. Meanwhile, when the ratio of the stem of the wasabi leaf exceeds 80% by mass, the fiber content becomes excessive and the product becomes hard. Thus, the ratio of the stem of the wasabi leaf is limited to 75 to 80% by mass in the wasabi leaf food of the present invention.

Further, the sensation of real wasabi can be realized by containing the root in the remaining portion, i.e., making the ratio of the root of the wasabi leaf 10 to 20% by mass.

That is, when the ratio of the root of the wasabi leaf is less than 10% by mass, the sensation of real wasabi, such as the pungent taste, the fragrance, and full flavor cannot be realized. Meanwhile, when the ratio of the root of the wasabi leaf exceeds 20% by mass, the product becomes expensive. Thus, the ratio of the root of the wasabi leaf is limited to 10 to 20% by mass in the wasabi leaf food of the present invention.

The sensation of real wasabi and the eating texture are realized by making the grain diameter of the wasabi leaf 1 mm to 5 mm. That is, when the grain diameter of the wasabi leaf is less than 1 mm, the sensation of real wasabi, such as the pungent taste, the fragrance, and full flavor are easily lost. Meanwhile, when the grain diameter of the wasabi leaf exceeds 5 mm, the eating texture deteriorates. Thus, the grain diameter of the wasabi leaf is limited to 1 mm to 5 mm in the wasabi leaf food of the present invention.

When the wasabi leaf occupies 95% by mass of the wasabi leaf food, this makes it possible to enjoy the eating texture while keeping the inherent fragrance of the wasabi more sufficiently.

By containing glycine in the wasabi leaf food, it is possible to make the inherent fragrance in wasabi last for a long time. Here, it is preferable to contain glycine in an amount of 0.5% by mass or more and 5% by mass or less. When the content of glycine is less than 0.5% by mass, the function of glycine to make the inherent fragrance in wasabi last for a long time cannot be exerted sufficiently. Meanwhile, even when the content of glycine exceeds 5% by mass, the function of glycine to make the inherent fragrance in wasabi last for a long time becomes saturated, as well as the ratio of the wasabi leaf being decreased in association with the increase in the content of glycine.

In order to achieve the above object, the wasabi leaf food of the present invention contains the leaf of the wasabi leaf having the grain diameter of 1 mm to 5 mm, the stem of the wasabi leaf having the grain diameter of 1 mm to 5 mm, and the root of the wasabi leaf having the grain diameter of 1 mm to 5 mm.

Here, the sensation of real wasabi and sufficient eating texture are realized by making the grain diameters of the leaf of the wasabi leaf, the stem of the wasabi leaf and the root of the wasabi leaf 1 mm to 5 mm. That is, when the grain diameter of the wasabi leaf is less than 1 mm, the sensation of real wasabi, such as the pungent taste, the fragrance, and the full flavor are easily lost. Meanwhile, when the grain diameter of the wasabi leaf exceeds 5 mm, the eating texture deteriorates. Thus, the grain diameter of the wasabi leaf is limited to 1 mm to 5 mm in the wasabi leaf food of the present invention.

In the wasabi leaf food of the present invention, sufficient eating texture can be enjoyed while keeping the inherent fragrance in wasabi.

### BRIEF DESCRIPTION OF THE DRAWINGS

FIG. 1 is a flowchart (1) for illustrating one example of a process for manufacturing the wasabi leaf food of the present invention.

FIG. 2 is a flowchart (2) for illustrating one example of a process for producing the wasabi leaf food of the present invention.

FIG. 3 is a view showing a result (1) of gas chromatographic analysis.

FIG. 4 is a view showing a result (2) of gas chromatographic analysis.

### DETAILED DESCRIPTION OF THE INVENTION

Hereinafter, modes for carrying out the invention (hereinafter, referred to as “embodiments”) will be described with reference to the drawings.

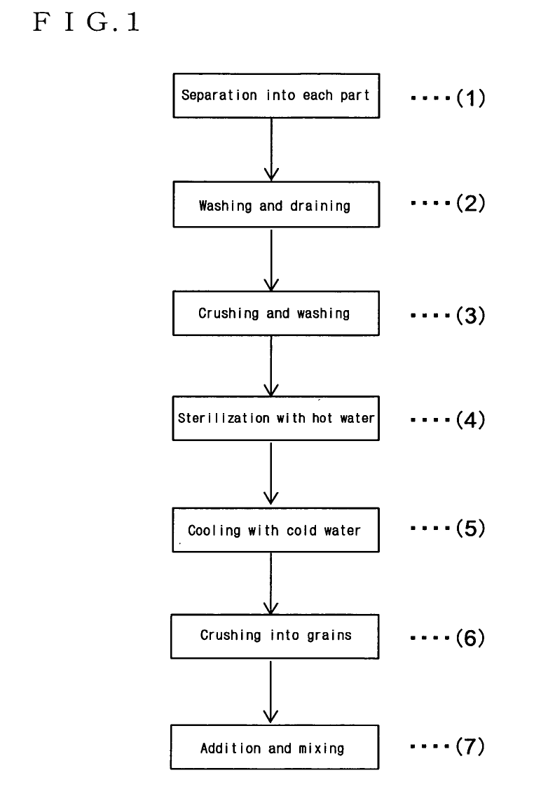

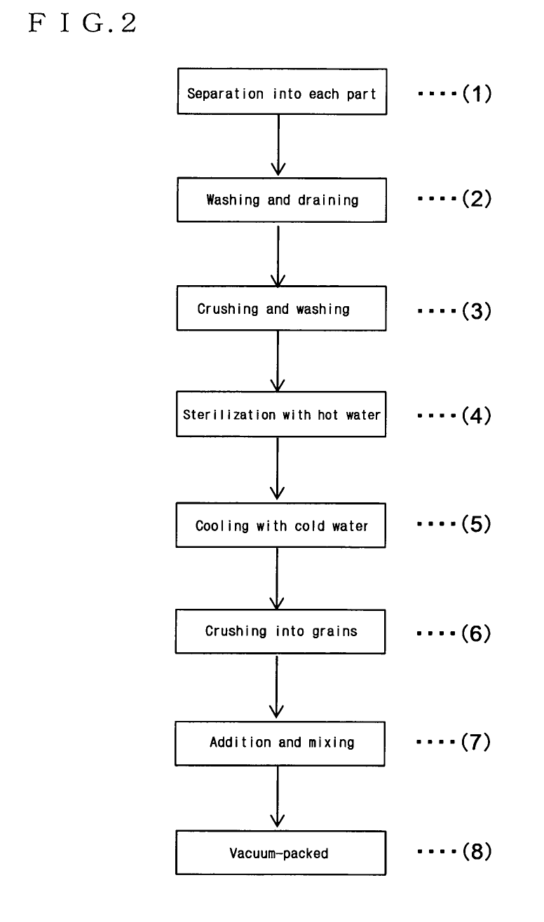

FIG. 1 and FIG. 2 are the flowcharts for illustrating one example of the process for producing the wasabi leaf food of the present invention. The wasabi produced in Nanayama, Saga prefecture was used in the present embodiments.

### 1. First Embodiment

In the process for manufacturing the wasabi leaf food of the present invention (1), first, the wasabi leaf (leaf, stem, and root parts) was separated into respective parts such as a leaf part, a stem part, and a root part (see symbol (1) in FIG. 1), and 50 g of the leaf part, 800 g of the stem part and 150 g of the root part corresponding to a total of 1 kg were taken, washed and drained (see symbol (2) in FIG. 1).

Then, the leaf part, the stem part, and the root part of the wasabi leaf were crushed into approximately 2 to 5 cm pieces, respectively, which were then washed again (see symbol (3) in FIG. 1).

Subsequently, the materials were sterilized and washed with hot water at 85° C. for approximately 30 seconds (see symbol (4) in FIG. 1), and then cooled with cold water at 5° C. (see symbol (5) in FIG. 1). The color of the wasabi leaf becomes brilliant by immersing the wasabi leaf in the hot water.

Then, the leaf, the stem, and the root of the wasabi leaf were crushed into grains of 1 mm to 5 mm using a food processor (see symbol (6) in FIG. 1).

Subsequently, trehalose and salt were added to the wasabi leaf and the mixture was thoroughly mixed to obtain the wasabi leaf food of the present invention (see symbol (7) in FIG. 1).

The ratio of the leaf of the wasabi leaf is 5% by mass, the ratio of the stem is 80% by mass and the ratio of the root is 15% by mass in the obtained wasabi leaf food. Also, the ratio of the wasabi leaf is 96% by mass, the ratio of trehalose is 0.5% by mass and the ratio of salt is 3.5% by mass in the wasabi leaf food.

Here, in the first embodiment, a color like real wasabi is realized, as well as realizing a product with no odor by making the ratio of the leaf of the wasabi leaf 5% by mass. When the ratio of the leaf of the wasabi leaf is less than 5% by mass, the coloration is insufficient, and the color that stimulates the appetite cannot be realized. Meanwhile, when the ratio of the leaf of the wasabi leaf exceeds 10% by mass, the raw taste is produced.

Also, in the first embodiment, sufficient eating texture is realized by making the ratio of the stem of the wasabi leaf 80% by mass. When the ratio of the stem of the wasabi leaf is less than 75% by mass, the eating texture becomes insufficient. Meanwhile, when the ratio of the stem of the wasabi leaf exceeds 80% by mass, the fiber content becomes excessive and the product becomes too hard.

Further, in the first embodiment, the sensation of real wasabi is realized by making the ratio of the root of the wasabi leaf 15% by mass. When the ratio of the root of the wasabi leaf is less than 10% by mass, the sensation of real wasabi, such as the pungent taste, the fragrance, and the full flavor cannot be realized. Meanwhile, when the ratio of the root of the wasabi leaf exceeds 20% by mass, the product becomes too expensive.

Also, in the first embodiment, the sensation of real wasabi and the eating texture are realized by crushing the leaf, the stem, and the root of the wasabi leaf into grains of 1 mm to 5 mm. When the grain diameter of the wasabi leaf (leaf, stem, and root parts) is less than 1 mm, the sensation of real wasabi, such as the pungent taste, the fragrance, and the full flavor are easily lost and sufficient eating texture cannot be sensed because the wasabi leaf is easily oxidized. Meanwhile, when the grain diameter of the wasabi leaf (leaf, stem, and root parts) exceeds 5 mm, the eating texture deteriorates.

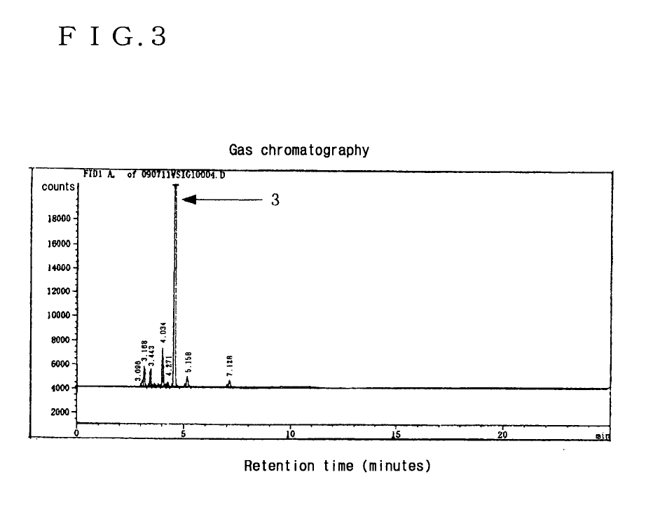

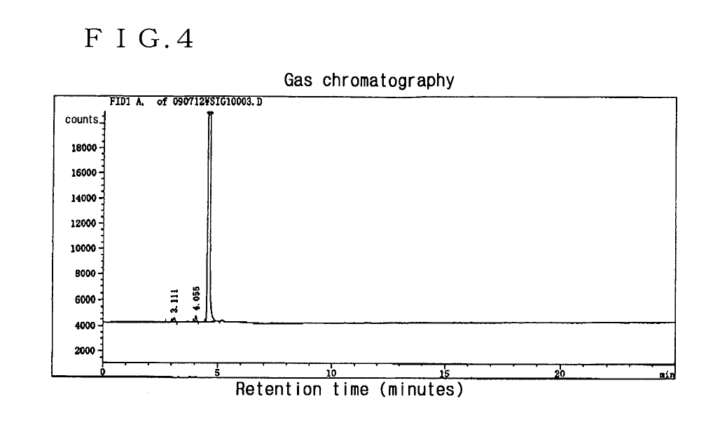

Here, FIG. 3 shows the results of gas chromatographic analysis of the wasabi leaf whose grain diameter is 1.5 mm, and FIG. 4 shows the results of gas chromatographic analysis of the wasabi leaf whose grain diameter is 0.5 mm. It is found that the wasabi leaf food in FIG. 3 keeps the sensation of real wasabi for a longer time.

### 2. Second Embodiment

In the process for manufacturing the wasabi leaf food of the present invention (2), as is the case with the aforementioned first embodiment, first, the wasabi leaf (leaf, stem, and root parts) was separated into respective parts such as a leaf part, a stem part, and a root part (see symbol (1) in FIG. 1), and 100 g of the leaf part, 750 g of the stem part and 150 g of the root part corresponding to a total of 1 kg were taken, washed and drained (see symbol (2) in FIG. 1).

Then, the leaf part, the stem part, and the root part of the wasabi leaf were crushed into approximately 2 to 5 cm pieces, respectively, which were then washed again (see symbol (3) in FIG. 1).

Subsequently, the materials were sterilized and washed with hot water at 85° C. for approximately 30 seconds (see symbol (4) in FIG. 1), and then, cooled with cold water at 5° C. (see symbol (5) in FIG. 1). The color of the wasabi leaf became brilliant by immersing the wasabi leaf in the hot water.

Then, the leaf, the stem, and the root of the wasabi leaf were crushed into grains of 1 mm to 5 mm using the food processor (see symbol (6) in FIG. 1).

Subsequently, trehalose and salt were added to the wasabi leaf and the mixture was thoroughly mixed to obtain the wasabi leaf food of the present invention (see symbol (7) in FIG. 1).

The ratio of the leaf of the wasabi leaf is 10% by mass, the ratio of the stem is 75% by mass and the ratio of the root is 15% by mass in the obtained wasabi leaf food. Also, the ratio of the wasabi leaf is 96% by mass, the ratio of trehalose is 0.5% by mass and the ratio of salt is 3.5% by mass in the wasabi leaf food.

Here, in the second embodiment, a color like real wasabi is realized, as well as realizing a product with no odor by making the ratio of the leaf of the wasabi leaf 10% by mass. When the ratio of the leaf of the wasabi leaf is less than 5% by mass, the coloration is insufficient, and the color that stimulates the appetite cannot be realized. Meanwhile, when the ratio of the leaf of the wasabi leaf exceeds 10% by mass, the raw taste is produced.

Also, in the second embodiment, sufficient eating texture is realized by making the ratio of the stem of the wasabi leaf 75% by mass. When the ratio of the stem of the wasabi leaf is less than 75% by mass, the eating texture becomes insufficient. Meanwhile, when the ratio of the stem of the wasabi leaf exceeds 80% by mass, the fiber content becomes excessive and the product becomes too hard.

Further, in the second embodiment, the sensation of real wasabi is realized by making the ratio of the root of the wasabi leaf 15% by mass. When the ratio of the root of the wasabi leaf is less than 10% by mass, the sensation of real wasabi, such as the pungent taste, the fragrance and full flavor cannot be realized. Meanwhile, when the ratio of the root of the wasabi leaf exceeds 20% by mass, the product becomes too expensive.

The point that the sensation like real wasabi and eating texture are realized by crushing the wasabi leaf (leaf, stem, and root parts) into grains of 1 mm to 5 mm is the same as in the above first embodiment.

### 3. Third Embodiment

In the process for producing the wasabi leaf food of the present invention (3), first, the wasabi leaf (leaf, stem, and root part) was separated into respective parts such as a leaf part, a stem part, and a root part (see symbol (1) in FIG. 2), and 50 g of the leaf part, 800 g of the stem part and 150 g of the root part corresponding to a total of 1 kg were taken, washed and drained (see symbol (2) in FIG. 2).

Then, the leaf part, the stem part, and the root part of the wasabi leaf were crushed into approximately 2 to 5 cm pieces, respectively, which were then washed again (see symbol (3) in FIG. 2).

Subsequently, the materials were sterilized and washed with hot water at 85° C. for approximately 30 seconds (see symbol (4) in FIG. 2), and then, cooled with cold water at 5° C. (see symbol (5) in FIG. 2). The color of the wasabi leaf became brilliant by immersing the wasabi leaf in the hot water.

Then, the leaf, the stem, and the root of the wasabi leaf were crushed into grains of 1 mm to 5 mm using the food processor (see symbol (6) in FIG. 2).

Subsequently, glycine was added to the wasabi leaf, which was then thoroughly mixed to obtain the wasabi leaf food of the present invention (see symbol (7) in FIG. 2).

Subsequently, the wasabi leaf food was filled into a polypropylene film bag, which was then vacuum-packed (see symbol (8) in FIG. 2).

The ratio of the leaf of the wasabi leaf is 5% by mass, the ratio of the stem is 80% by mass and the ratio of the root is 15% by mass in the obtained wasabi leaf food. Also, the ratio of the wasabi leaf is 95% by mass, and the ratio of glycine is 5% by mass in the wasabi leaf food.

Here, in the third embodiment, a color like real wasabi is realized, as well as realizing a product with no odor by making the ratio of the leaf of the wasabi leaf 5% by mass. When the ratio of the leaf of the wasabi leaf is less than 5% by mass, the coloration is insufficient, and the color that stimulates the appetite cannot be realized. Meanwhile, when the ratio of the leaf of the wasabi leaf exceeds 10% by mass, the raw taste is produced.

Also, in the third embodiment, sufficient eating texture is realized by making the ratio of the stem of the wasabi leaf 80% by mass. When the ratio of the stem of the wasabi leaf is less than 75% by mass, eating texture becomes insufficient. Meanwhile, when the ratio of the stem of the wasabi leaf exceeds 80% by mass, the fiber content becomes excessive and the product becomes too hard.

Further, in the third embodiment, the sensation like real wasabi is realized by making the ratio of the root of the wasabi leaf 15% by mass. When the ratio of the root of the wasabi leaf is less than 10% by mass, the sensation like real wasabi, such as the pungent taste, the fragrance, and full flavor cannot be realized. Meanwhile, when the ratio of the root of the wasabi leaf exceeds 20% by mass, the product becomes too expensive.

The point that the sensation like real wasabi and eating texture are realized by crushing the wasabi leaf (the leaf, the stem, and the root) into grains of 1 mm to 5 mm is the same as in the above first and second embodiments.

Also, in the third embodiment, glycine is added, and the inherent fragrance in wasabi can be strongly sensed and the inherent fragrance in wasabi can be made to last for a long time. Further, in the third embodiment, by being vacuum-packed, it becomes possible to store for a long time.

As is clear from the aforementioned first, second and third embodiments, the eating texture can be enjoyed while keeping the inherent fragrance in wasabi in the wasabi leaf food of the present invention.

Also, the wasabi leaf food of the present invention is easily mixed with various foods because of its grain form, thus, it can be variously applied to many purposes. For example, the wasabi leaf food is mixed with, for example, bean curd, dressing, bean paste, and soy sauce, thus, it can be variously applied to many purposes.

1. A wasabi leaf food comprising wasabi leaf in which a leaf part is 5 to 10% by mass, a stem part is 75 to 80% by mass, and a remaining part is a root part, as well as grain diameters are 1 mm to 5 mm.

2. The wasabi leaf food according to claim 1, wherein the wasabi leaf food comprises the wasabi leaf in an amount of 95% or more by mass.

3. The wasabi leaf food according to claim 1, wherein the wasabi leaf food comprises glycine.

4. The wasabi leaf food according to claim 3, wherein the wasabi leaf food comprises the glycine in an amount of 0.5 to 5% by mass.

5. A wasabi leaf food comprises a leaf part of wasabi leaf having a grain diameter of 1 mm to 5 mm, a stem part of the wasabi leaf having a grain diameter of 1 mm to 5 mm, and a root part of the wasabi leaf having a grain diameter of 1 mm to 5 mm.

6. The wasabi leaf food according to claim 2, wherein the wasabi leaf food comprises glycine.

7. The wasabi leaf food according to claim 6, wherein the wasabi leaf food comprises the glycine in an amount of 0.5 to 5% by mass.
